(19) United States
(12) Patent Application Publication
(10) Pub. No.: US 2013/0086477 A1
(43) Pub. Date: Apr. 4, 2013

(54) Systems and Methods for Status Updates

(71) Applicant: Julie Newrai, Excelsior, MN (US)

(72) Inventor: Julie Newrai, Excelsior, MN (US)

(73) Assignee: PreciouStatus LLC, Lakeville, MN (US)

(21) Appl. No.: 13/630,580

(22) Filed: Sep. 28, 2012

Related U.S. Application Data
(60) Provisional application No. 61/540,847, filed on Sep. 29, 2011.
(60) Provisional application No. 61/663,305, filed on Jun. 22, 2012.

(51) Int. Cl. G06F 3/01

(52) U.S. Cl. 715/738

(57) ABSTRACT

A method for providing status updates using a device. The method may include displaying a plurality of units on one or more displays, receiving a unit selection from the displayed plurality of units, determining a plurality of care receivers based on the received unit selection, displaying the plurality of care receivers on the one or more displays, receiving a selection of a care receiver, determining a plurality of tools based on the received unit selection, the tools of the plurality of tools corresponding to interfaces for providing status updates for care receivers, displaying the plurality of tools, receiving a selection of a tool, generating a status update for the selected care receiver based on the received selection of the care receiver and the received selection of the tool, and providing the generated status update for a second device.

This application claims the benefit of U.S. Provisional Application No. 61/663,305, filed Jun. 22, 2012 (attorney docket no.: 122289-334500) and of U.S. Provisional Application No. 61/540,847 filed Sep. 29, 2011 (attorney docket no.: 122289-327990) the entire disclosures of which are herein incorporated by reference.

### FIELD OF THE INVENTION

1. Field of the Invention

The present invention relates to the field of monitoring status of individuals, including, for example, persons, animals and/or entities, and, in particular, systems and methods for providing status updates regarding one individual to another, remote individual, including, for example, persons, animals and/or entities.

2. Background of Invention

Current systems for providing updates regarding individuals, persons, animals and/or entities receiving care do not allow for real-time monitoring and updates. As such, parents, family members, etc., cannot necessarily receive all relevant information in a timely manner. Therefore, needs exist for systems that provide detailed information in real or near-real time.

### SUMMARY OF INVENTION

The present invention solves the limitations of prior systems with unique features that allow monitoring of individuals, including, for example, persons, animals and/or entities receiving care and providing updates to designated individuals, including, for example, persons, animals and/or entities.

Embodiments of the present invention include systems and methods for monitoring individuals and providing status updates.

In one embodiment, a method for providing status updates using a device is disclosed. The device may include one or more processors, one or more displays, and one or more input interfaces. The method includes displaying a plurality of units on the one or more displays, the units corresponding to locations within a facility, receiving using the one or more input interfaces a unit selection from the displayed plurality of units, determining, using the one or more processors, a plurality of care receivers based on the received unit selection, displaying the plurality of care receivers on the one or more displays, receiving, using the one or more input interfaces, a selection of a care receiver, determining, using the one or more processors, a plurality of tools based on the received unit selection, the tools of the plurality of tools corresponding to interfaces for providing status updates for care receivers, displaying the plurality of tools on the one or more displays, receiving, using the one or more input interfaces, a selection of a tool, generating, using the one or more processors, a status update for the selected care receiver based on the received selection of the care receiver and the received selection of the tool, and providing, using the one or more processors, the generated status update for a second device.

In another embodiment, at least one non-transitory tangible computer-readable medium holding instructions is disclosed. The instructions, when executed by at least one computing device, cause the at least one computing device to provide a status update. The instructions include one or more instructions for displaying a plurality of units, the units of the plurality of units corresponding to locations within a facility, one or more instructions for receiving a unit selection from the displayed plurality of units, one or more instructions for determining a plurality of care receivers based on the received unit selection, one or more instructions for displaying the plurality of care receivers, one or more instructions for receiving a selection of a care receiver, one or more instructions for determining a plurality of tools based on the received unit selection, the tools of the plurality of tools corresponding to interfaces for providing status updates for care receivers, one or more instructions for displaying the plurality of tools, one or more instructions for receiving a selection of a tool, one or more instructions for generating a status update for the selected care receiver based on the received selection of the care receiver and the received selection of the tool, and one or more instructions for providing the generated status update for a second device.

In a further embodiment, a system to provide status updates is disclosed. The system includes one or more tangible non-transitory media storing program data, and one or more processors coupled to the one or more tangible non-transitory media. The processor is configured to define a plurality of units corresponding to locations within a facility, define a plurality of care receivers associated with the plurality of units, define a plurality of tools associated with the plurality of units, provide the plurality of units, plurality of care receivers, and plurality of tools to a client computing device, receive a status update from the client computing device, update the program data based on the received status update, and provide the status update to a second client computing device.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE FIGURES

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 shows an exemplary system for status updates, according to one embodiment.

FIG. 2 shows an exemplary server/computing device, according to one embodiment.

FIG. 3 shows a daycare facing sitemap for both daycare workers and daycare administrators.

FIG. 4 shows a parent facing sitemap, according to one embodiment.

FIG. 5 shows a daycare dashboard with all children checked in for a particular day, according to one embodiment.

FIG. 6 shows a daycare dashboard (scrolled) with an activity stream for a particular child, according to one embodiment.

FIG. 7 shows a daycare children listing of children that are checked in and not checked in, according to one embodiment.

FIG. 8 shows a child detail page of daily info with detailed information for a particular child, according to one embodiment.

FIG. 9 shows a child detail page of daily info (scrolled) with a time line of activities for a particular child, according to one embodiment.

FIG. 10 shows a child detail page of daily info to select activity or not with an interface with selectable menus, according to one embodiment.

FIG. 11 shows a child detail page of more info with a child information page, according to one embodiment.

FIG. 12 shows a daycare check in/check out page, according to one embodiment.

FIG. 13 shows a daycare check-in landing system for checking a child in, according to one embodiment.

FIG. 14 shows a daycare check-in single-child select system where children present and not present are displayed, according to one embodiment.

FIG. 15 shows a daycare check-in complete form filled-in example of the system of FIG. 13, according to one embodiment.

FIG. 16 shows a daycare check-out landing system for children, according to one embodiment.

FIG. 17 shows a daycare check-out single-child select system for children, according to one embodiment.

FIG. 18 shows a daycare check-out complete form system for children, according to one embodiment.

FIG. 19 shows a daycare activity/note landing system, according to one embodiment.

FIG. 20 shows an exemplary daycare add meal/snack landing activity entry, according to one embodiment.

FIG. 21 shows an exemplary daycare add bathroom landing activity entry, according to one embodiment.

FIG. 22 shows a daycare message landing system, according to one embodiment.

FIG. 23 shows a daycare messages message detail reading system, according to one embodiment.

FIG. 24 shows a parent dashboard with all children whose information is available to, according to one embodiment.

FIG. 25 shows parent dashboard (scrolled) with a selection page, according to one embodiment.

FIG. 26 shows a parent child-info child selection page (2 or more children), according to one embodiment.

FIG. 27 shows a parent child-info child selection dropdown system, according to one embodiment.

FIG. 28 shows a parent child-info with a child selected child overview system, according to one embodiment.

FIG. 29 shows a parent child-info select child (single child) system with additional information, such as details regarding particular activities for a selected child, according to one embodiment.

FIG. 30 shows potential actions for a user on a parent child-info select action screen, according to one embodiment.

FIG. 31 shows an activity stream for a selected child on a parent child-info child selected (scrolled) screen, according to one embodiment.

FIG. 32 shows child information on a parent child-info more info screen, according to one embodiment.

FIG. 33 shows parent child check in landing (two or more children) where the user may select a child for check in, according to one embodiment.

FIG. 34 shows potential selections for children and check in status on a parent check-in single child select screen, according to one embodiment.

FIG. 35 shows a data entry system for check in on a parent check-in child selected screen, according to one embodiment.

FIG. 36 shows the form of FIG. 35 completed on a parent check-in completed screen, according to one embodiment.

FIG. 37 shows a message receiving system on a parent reminders landing (2 or more children) screen, according to one embodiment.

FIG. 38 shows a parent reminders detail system, according to one embodiment.

FIG. 39 shows a parents message staff landing system for allowing a parent to message a staff member and/or the facility, according to one embodiment.

FIG. 40 shows a selection system for linking messages to one or more children on a parents message staff single child select screen, according to one embodiment.

FIG. 41 shows an email message system on a parents message staff completed form 2 screen, according to one embodiment.

FIG. 42 shows a parent center information/staff information system, according to one embodiment.

FIG. 43 shows a system for daycare worker user actions, according to one embodiment.

FIG. 44 shows a system for daycare administrator user actions, according to one embodiment.

FIG. 45 shows parent user actions, according to one embodiment.

FIG. 46 shows an interface for site administration, according to one embodiment.

FIG. 47 shows an interface for listing activities, according to one embodiment.

FIG. 48 shows an interface for listing facilities, according to one embodiment.

FIG. 49 shows an interface for listing monitoring individuals, according to one embodiment.

FIG. 50 shows an interface for listing care receivers, according to one embodiment.

FIG. 51 shows an interface for listing units, according to one embodiment.

FIG. 52 shows an exemplary process for providing status updates, according to one embodiment.

FIG. 53 shows an exemplary process for switching users, according to one embodiment.

FIG. 54 shows an exemplary process for associating updates with care providers, according to one embodiment.

FIG. 55 shows an exemplary process for communicating between monitoring individuals and care providers, according to one embodiment.

FIG. 56 shows an exemplary process for providing questions to monitoring individuals, according to one embodiment.

### DETAILED DESCRIPTION OF THE EMBODIMENTS

Methods and systems are provided that allow for monitoring of individuals, including, for example, persons, animals and/or entities that are receiving care, and status updates to designated individuals, including, for example, persons, animals and/or entities. Embodiments of the present invention may allow individuals, including, for example, persons, animals and/or entities to receive instant updates regarding the status of loved ones receiving care throughout the day. This may include updates on how or what they are doing, reminders, requests, any needed items, etc. Status updates may be received anywhere via Internet browsers, software, mobile apps for all types of phones, tablets, computers, etc. Updates may be received in the form of e-mail messages, text messages, mobile app messages, etc. Updates may be received at any intervals, such as daily, upon each new activity entered at the care facility, at the end of the day, etc.

Individuals wishing to monitor others may sign up for status updates through a website and/or via a care providing facility that uses the systems described herein. Preferences may be set by a user. Preferably, the relationship between the individual receiving updates and the individual receiving care is verified and authorized. Preferably, all personal information and data exchanges are secure. For example, the systems and methods of the present invention may use 128-bit SSL or similar types of encryption.

The following examples are related specifically to daycare environments, but it is understood that the methods and systems described therein would apply equally to a wide variety of settings, including, but not limited to, daycare (infants, toddlers, pre-school), schools/learning centers, rehabilitation residents, hospitals, eldercare residents, assisted healthcare in homes or other facilities, pet residents (doggy daycare, etc.). For example, the system may provide storage of and access to status updates with respect to pets in the care of others, including pets in kennels, pets in veterinary hospitals, and pets in pet care.

Although not required, the systems and methods are described in the general context of computer program instructions executed by one or more computing devices. Computing devices typically include one or more processors coupled to data storage for computer program modules and data. Such program modules generally include computer program instructions such as routines, programs, objects, components, etc., for execution by the at least one processor to perform particular tasks, utilize data, data structures, and/or implement particular abstract data types. While the systems, methods, and apparatus are described in the foregoing context, acts and operations described hereinafter may also be implemented in hardware.

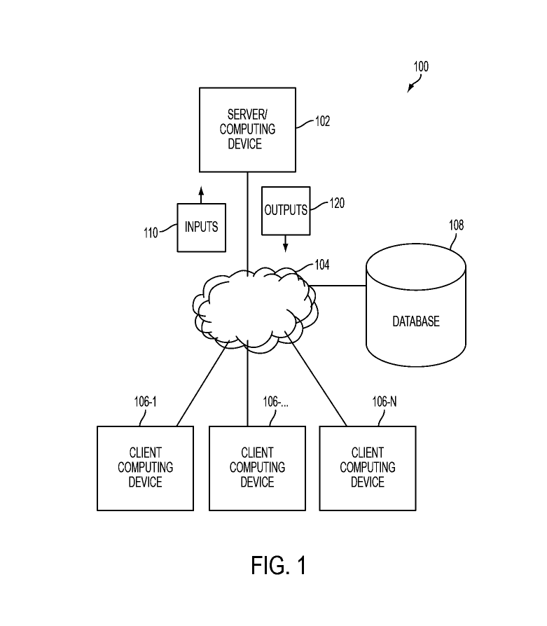

FIG. 1 shows an exemplary system 100 for status updates, according to one embodiment. In this exemplary implementation, system 100 includes server/computing device 102 operatively coupled over network 104 to one or more client computing devices 106 (e.g., 106-1 through 106-N) and one or more databases 108.

Server/computing device 102 represents, for example, any one or more of a server, a general-purpose computing device such as a server, a personal computer (PC), a laptop, and/or so on.

Networks 104 represent, for example, any combination of the Internet, local area network(s) such as an intranet, wide area network(s), and/or networking environments are commonplace in offices, enterprise-wide computer networks, etc.

Client computing devices 106, which may include at least one processor, represent a set of arbitrary computing devices executing application(s) that respectively send data inputs 110 to server/computing device 102 and/or receive data outputs 120 from server/computing device 102 via network 104. Such computing devices include, for example, one or more of desktop computers, laptops, mobile computing devices (e.g., PDAs, smartphones, tablets, etc.), server computers, and/or so on. Client computing devices 106 may be used by care providers and/or individuals wishing to provide and/or receive status updates.

In this implementation, the input data comprises, for example, updates about a loved one received by server/computing device 102 from a client computing device 106 used by a care provider. In one implementation, the data outputs include, for example, updates about a loved one sent to a client computing device 106 of an individual by server/computing device 102 used by an individual wishing to receive status updates.

Server/computing device 102, database 108, and client computing devices 106 may be in communication via network 104. Alternatively, server/computing device 102 and database 108 may be integrated together to allow communication between server/computing device 102 and database 108 without using network 104.

Embodiments of the present invention may also be used collaboratively with multiple users logging in and performing various operations from various locations. Embodiments of the present invention may be web-based.

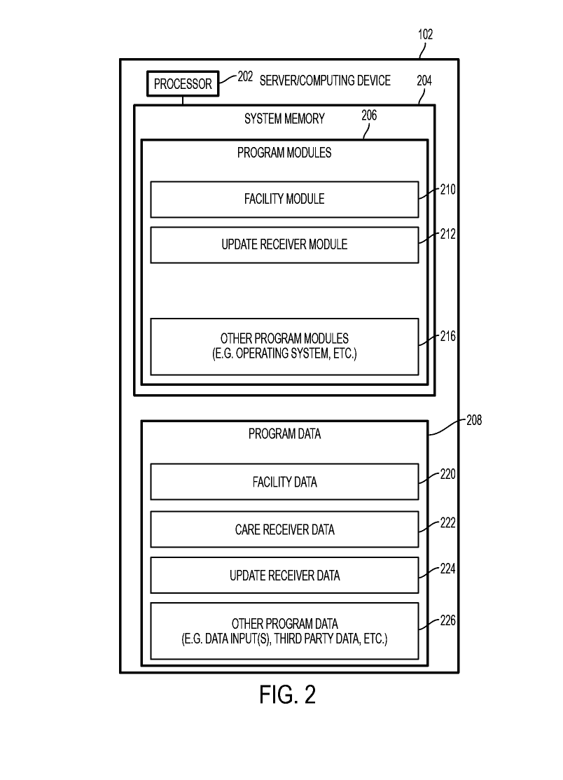

In this exemplary implementation, server/computing device 102 includes at least one processor 202 coupled to a system memory 204, as shown in FIG. 2. System memory 204 includes computer program modules 206 and program data 208.

In this implementation program modules 206 may include facility module 210 and update receiver module 212, and other program modules 216 such as an operating system, device drivers, etc. Each program module 210 through 216 may include a respective set of computer-program instructions executable by processor(s) 202. This is one example of a set of program modules and other numbers and arrangements of program modules are contemplated as a function of the particular arbitrary design and/or architecture of server/computing device 102 and/or system 100 (FIG. 1). Additionally, although shown on a single server/computing device 102, the operations associated with respective computer-program instructions in the program modules 206 could be distributed across multiple computing devices.

Facility module 210 may provide for the setup and administration of system 100. Facility module 210 may provide for a set of user interfaces and corresponding back-end software which permits system 100 to be set up for one or more caregiving facilities. These interfaces may allow an administrator to define one or more caregiving facilities, which may represent physical facilities, for example, daycares. The interfaces may allow each caregiving facility to be defined to include one or more units.

Units may represent locations within a caregiving facility. For example, the unit may represent a room in a daycare, a wing in a hospital, rooms in or portions of other settings, including, but not limited to, daycare (infants, toddlers, pre-school), schools/learning centers, rehabilitation residents, hospitals, eldercare residents, assisted healthcare in homes or other facilities, pet residents (doggy daycare, etc.), kennels, veterinary hospitals, etc. The definition of units may include definitions of associations to loved ones, caregivers, and tools. Loved ones associated with a unit may correspond with loved ones located in the physical room represented by the unit. Caregivers associated with a unit may correspond with caregivers located in the physical room represented by the unit that provide care to a loved one. Tools associated with a unit may correspond with tools useable by the caregivers within the unit. Tools include interfaces and back-end software for a caregiver to provide status updates regarding a loved one.

A caregiver may be any persons, animals (e.g., a guide dog or other helper animal) and/or entities. A caregiver may be any person or animal, including but not limited to a person or animal at a daycare, a hospital, a school, a learning center, a rehabilitation center, an eldercare facility, a home, an assisted healthcare facility, a pet residence, a doggy daycare, a kennel, a veterinary hospital, etc. A caregiver may be a hospital employee, a daycare employee, a school employee, a learning center employee, a resident, a facility employee, a person at a home, etc.

For example, facility module 210 may be used to define a physical room for infants in a daycare. A unit of the caregiving facility may be defined to include all the infants in the physical room as associated loves ones, and all the caregivers in the physical room as associated caregivers.

Facility module 210 may also include interfaces and back-end software so that caregivers may retrieve information about loved ones and individuals monitoring loved ones may receive updates provided by caregivers through the tools. For example, facility module 210 may detect a new status update about a loved one received by server/computing device 102 through a tool used by a caregiver and send a corresponding status update to the individual monitoring the loved one.

Update receiver module may include the tools associated with units. Tools may include tools for providing updates on moods, supplies, activities, visitors, naps, arrivals, departures, and photos. Tools may provide for the interfaces that appear on client computing devices so that caregivers can provide updates, as well as processing on the server/computing device 102 for receiving the updates and providing the updates to individuals wishing to receive updates about loved ones.

Program data 208 may include facility data 220, care receiver data 222, update receiver data 224, and other program data 226 such as data input(s), third party data, and/or so on.

Facility data 220 may include data regarding the facility, for example, definitions of units including associations to loved ones and care providers. Facility data 220 may also include data regarding the care providers, for example, name, experience, loved ones providing care to, login security information, etc. Care receiver data 222 may include data regarding a loved one, for example, name, age, gender, allergies, previous status updates, identification of individuals to receive updates about the loved one, etc. A care receiver may be any person or animal, including but not limited to a person or animal at a daycare, a hospital, a school, a learning center, a rehabilitation center, an eldercare facility, a home, an assisted healthcare facility, a pet residence, a doggy daycare, a kennel, a veterinary hospital, etc. A care receiver may be an infant, a toddler, a pre-school student, a student, a resident, a pet, etc. Update receiver data 224 includes data regarding the individuals receiving updates, for example, identification of loved ones to receive updates about, types of updates to receive, login security information, etc.

For example, facility data 220 may include the unit in which a loved one or care provider is currently located. Facility data 220 may include any information associated with a unit.

System 100 may streamline the process of providing status updates based on filtering tools provided to a caregiver using program modules 206 and program data 208. As described above, facility module 210, update receiver module 212, and facility data can be used to associate units of a facility with loved ones, caregivers, and tools. Tools may be modular so that for a caregiver associated with a unit, only the tools that are associated with the unit will appear on a client computing device used by the caregiver. For example, a tool for naps may be associated with a unit for infants but not for a unit for middle school children.

The following is an example of a streamlined process for a caregiver to provide a status update. A caregiver may be first presented on a client computing device 106 with units the caregiver is associated with. The units presented may be determined by client computing device 106 and/or server/computing device 102 using facility module 210. The determination may be based on the units associated with the caregiver as defined in facility data 220 during an administrative process using facility module 210. The client computing device 106 may determine the units to present, the server/computing device 102 may determine the units to present and notify the client computing device 106 which units to present, or the determination may be made in a combination by client computing device 106 and server/computing device 102.

The client computing device 106 may receive a unit selection from the caregiver and then present the loved ones associated with the selected unit. Presentation of the loved ones associated with the selected unit may also be made by client computing device 106 and/or server/computing device 102 in any combination based on facility data 220 and care receiver data 222 by determining the loved ones associated with the selected unit.

Client computing device 106 may then receive a selection of a loved one and present tools for providing updates based on the tools associated with the unit associated with the loved one. Presentation of the tools may also be made by client computing device 106 and/or server/computing device 102 in any combination based on facility data 220 and care receiver data 222 by determining the tools associated with the selected unit.

The order of selecting a unit, then loved one, then tool may be modified. For example, a unit may be selected, then a tool selected, and then a child selected. In another example, a tool may be first selected, loved ones to which the tool is associated with determined based on the units the loved ones are associated with, and then the loved ones presented and selected from. Program data 208 may even include a direct association between loved ones and tools so that determination may be made without referring to unit associations.

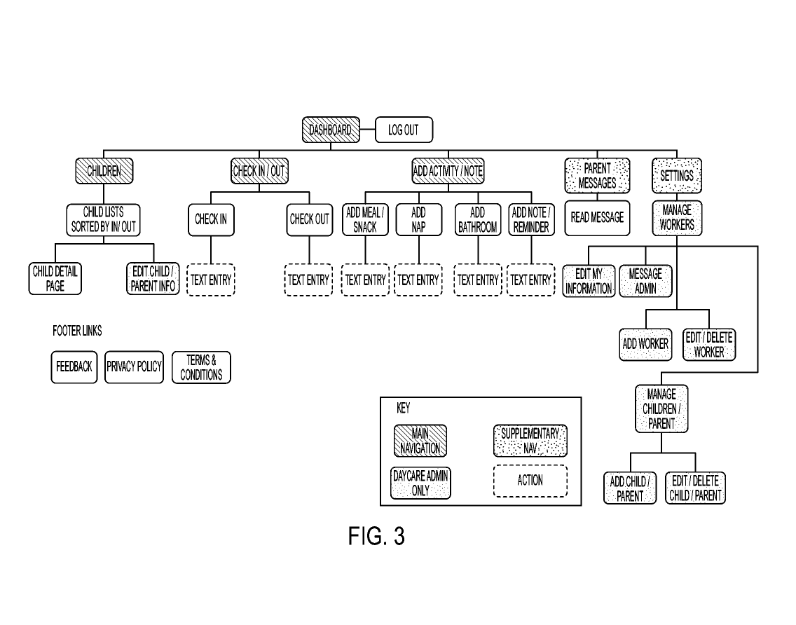

FIG. 3 shows a daycare facing sitemap for both daycare workers and daycare administrators. Initially, a daycare worker or administrator may enter or login to the system through a dashboard or other similar system. Options may include a listing of children for which care may be provided. The children may be sorted by checked in/checked out status, name, etc. The user may select a child to receive additional information about the child, parents, etc. The user may edit any information, if necessary. In another aspect, children may be checked in/checked out for a particular session. Text may be entered, if necessary. During care, the user may periodically enter the system to include status updates on activities. These may include, but are not limited to, meals/snacks, naps, bathroom information, notes/reminders. Text may be entered with each entry, if necessary. Status updates may also include photos of children. The systems and methods of the present invention may also include a system for receiving and/or sending messages to individuals wishing to receive updates, such as parent, family members, etc. The message system may include systems such as email, text messages, phone messages, website postings, etc. Messages may be sent individually or to groups of individuals. The user may also have the ability to modify settings. This may include editing personal information, message administrative settings, managing workers at a facility by adding, editing and/or deleting workers, and managing children and parent information, such as adding, editing and/or deleting children and parent information.

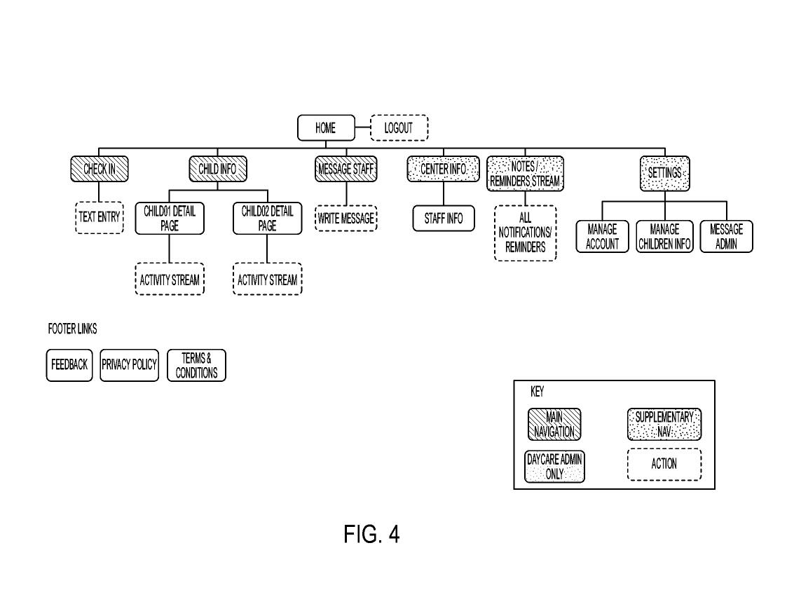

FIG. 4 shows a parent facing sitemap. A parent or other authorized individual may access the system through a dashboard, mobile application, website, etc. The individual may review information including check in and related text, child information for one or more children, including activity streams and related text, messages from the facility, notes and reminders, and settings. The system may provide the ability to send and receive messages with staff and/or the facility. While not shown in the sitemap, individuals may also be able to upload photos to server/computing device 102 so caregivers will be notified to show the photo to the loved one or a digital photo frame is automatically updated to show the photo. In an example, an individual may e-mail a digital photo to a specific e-mail address associated with the server/computing device 102. The user may also review and/or adjust settings such as account management, managing child information, and message settings.

Another option not shown in the sitemap is that individuals may be able to provide feedback to the staff and/or the facility. For example, an individual may be able to appreciate a status update made by a caregiver. Facility module 210 may allow for viewing the number and type of status updates that each caregiver has provided, as well as the number of appreciations that each caregiver has received. Caregivers may be rewarded based on the feedback received from individuals.

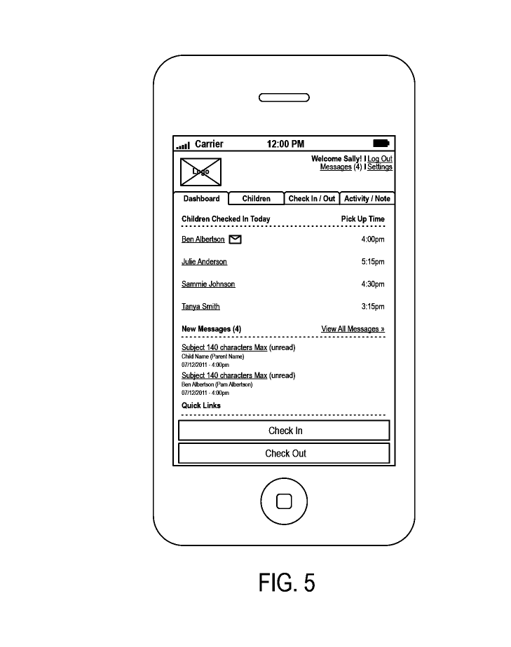

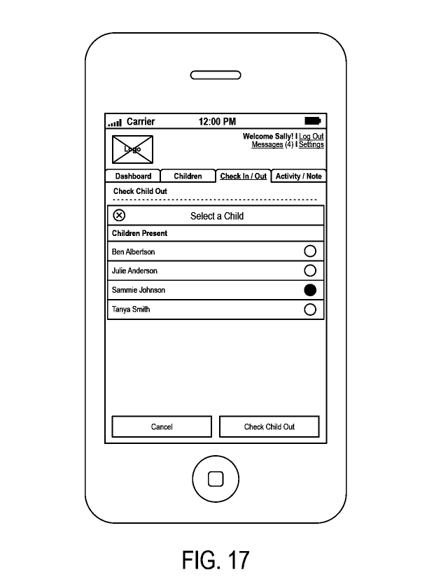

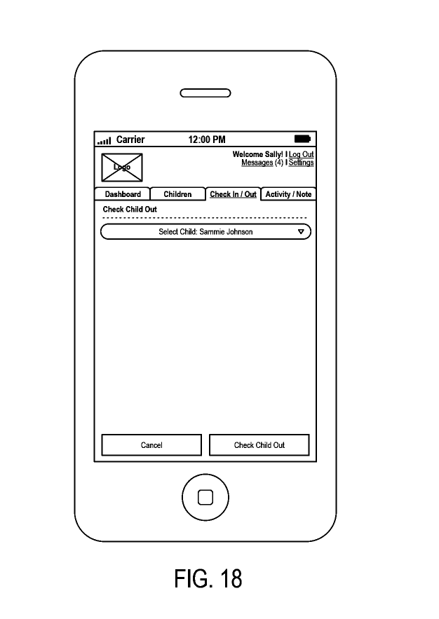

FIGS. 5-23 show exemplary screenshots of various daycare facing activities via the systems and methods of the present invention.

FIG. 5 shows a dashboard with all children checked in for a particular day. Data may include the child's name, when they were checked in, messages, etc. The user may select a child's name to receive additional information. Entry devices for check in and check out may be provided to change the status of a particular child.

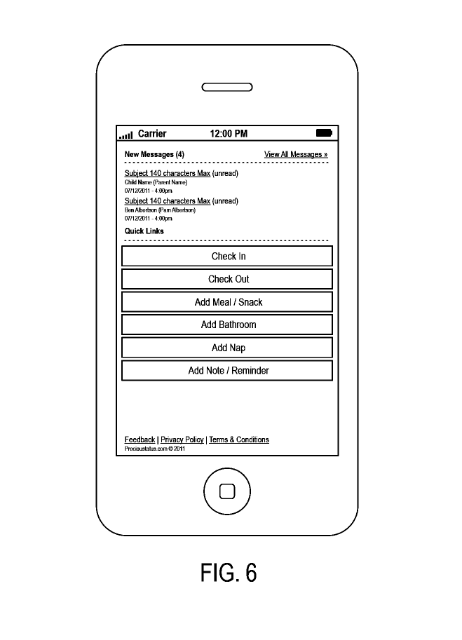

FIG. 6 shows an activity stream for a particular child. The user may select an activity, such as check in, check out, add meal/snack, add bathroom, add nap, add note/reminder. The user will then be taken to the appropriate subsystem where information may be entered.

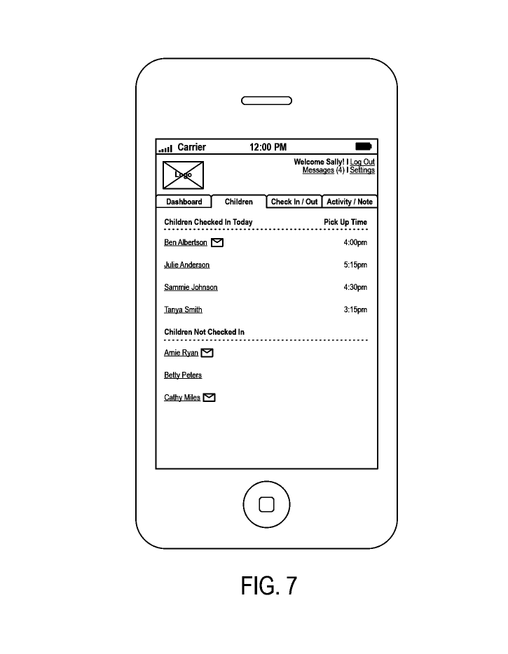

FIG. 7 shows a listing of children that are checked in and not checked in.

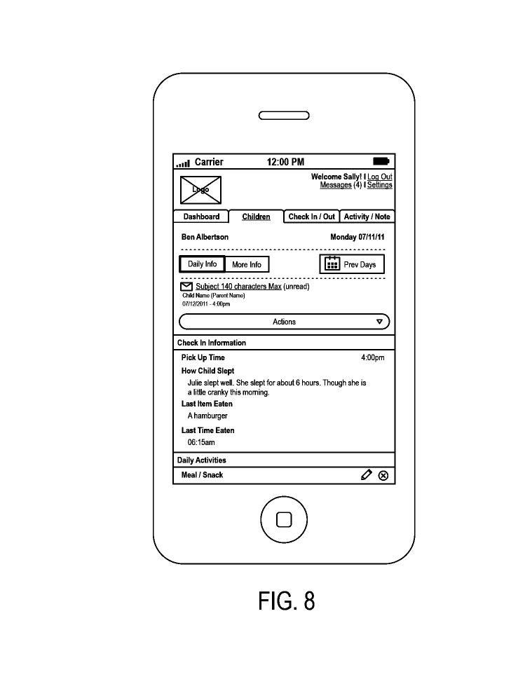

FIG. 8 shows detailed information for a particular child. Information may include, but is not limited to, pick up time, sleeping information, eating information, etc. Links may also be provided to previous day information, messages, etc.

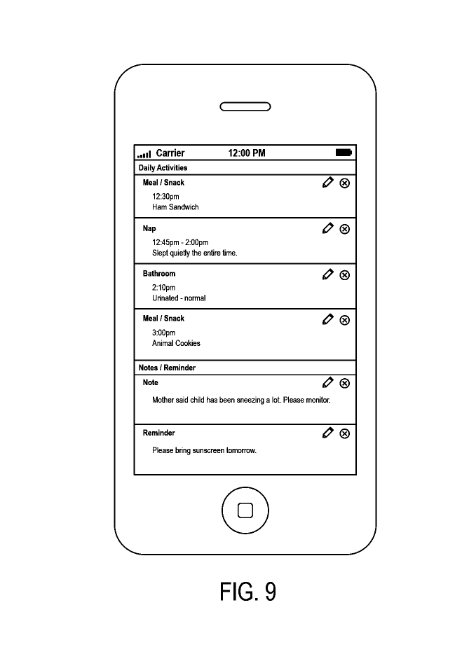

FIG. 9 shows a timeline of activities for a particular child. The activities may be grouped by type and/or presented chronologically. The timeline may also display messages and/or reminders.

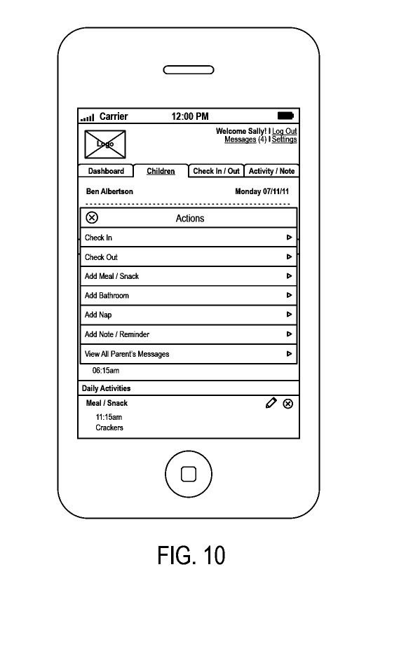

FIG. 10 shows an interface with selectable menus. A user may be presented with a graphical user interface that allows them to select an activity. The system may then provide a sub-menu, and further sub-menus for particular activities. The user may enter information at some or all of these menus.

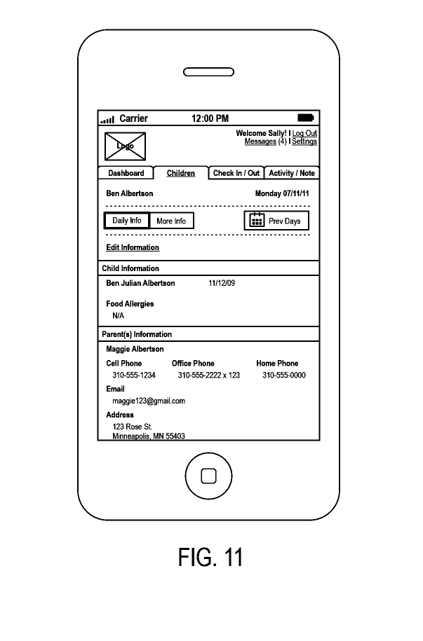

FIG. 11 shows a child information page. Information may include name, birthday, food allergies, parent information, etc.

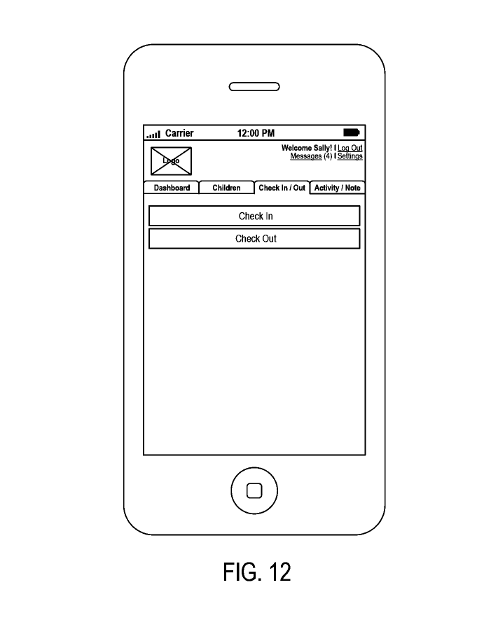

FIG. 12 shows a check in/check out page.

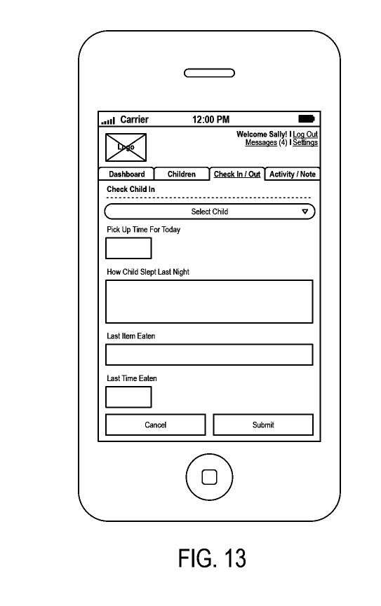

FIG. 13 shows a system for checking a child in. A drop-down or other type listing may allow the user to select a particular child. The time of pick-up may be entered, as well as information about prior sleeping patterns, prior items eaten and times, etc.

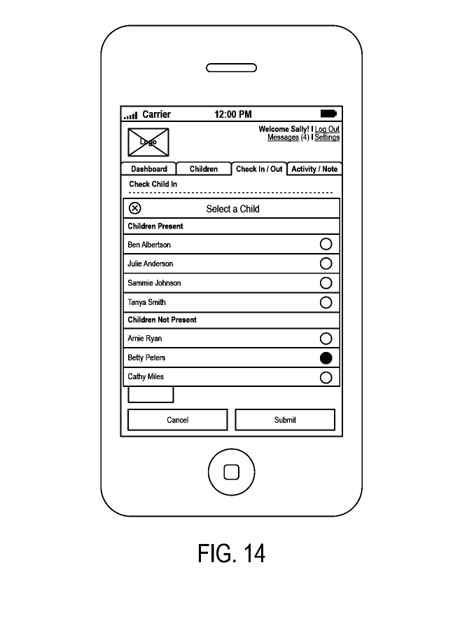

FIG. 14 shows a system where children present and not present are displayed. One or more graphic indicators may be used to convey additional information.

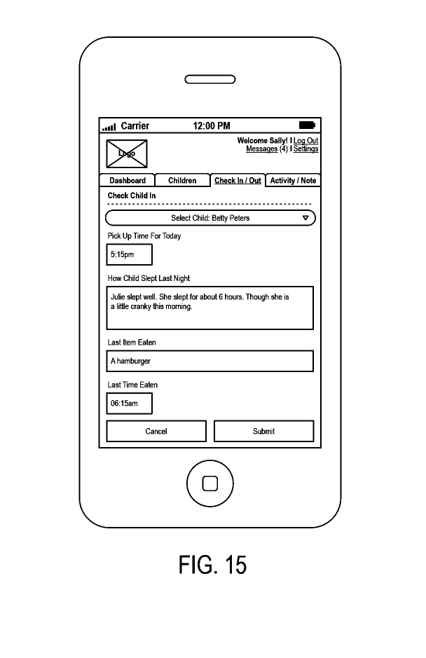

FIG. 15 shows a filled-in example of the system of FIG. 13.

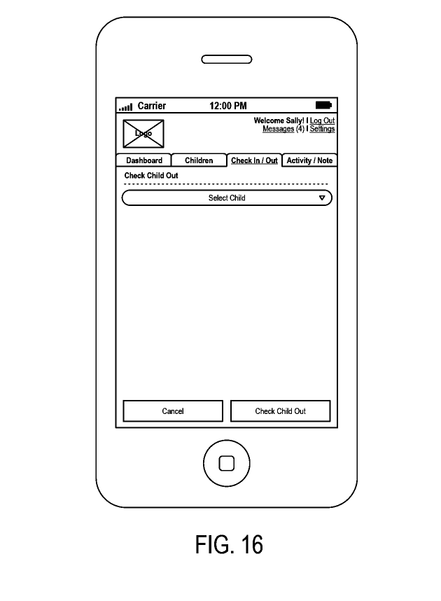

FIGS. 16-18 show a check out system for children that operates similarly to the system for check in of FIGS. 12-15.

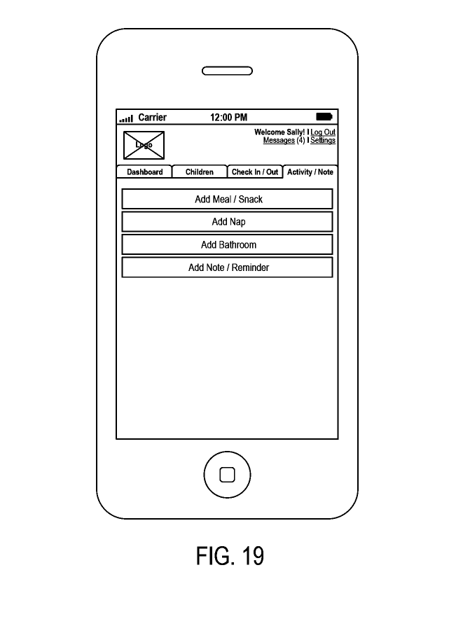

FIG. 19 shows an activity/note system. A user may select an activity, such as add meal/snack, add nap, add bathroom, and/or add note/reminder.

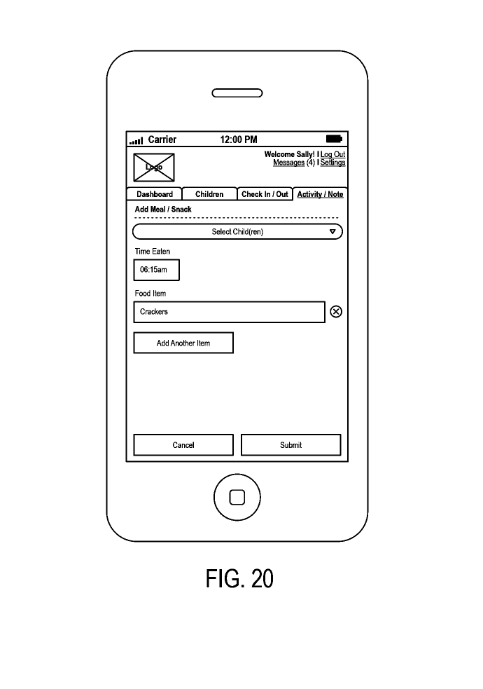

FIG. 20 shows an exemplary activity entry. In this example, a meal/snack is added, where one or more children are selected, the time is entered either automatically or manually, food items are entered, etc. Additional items may be added, if necessary.

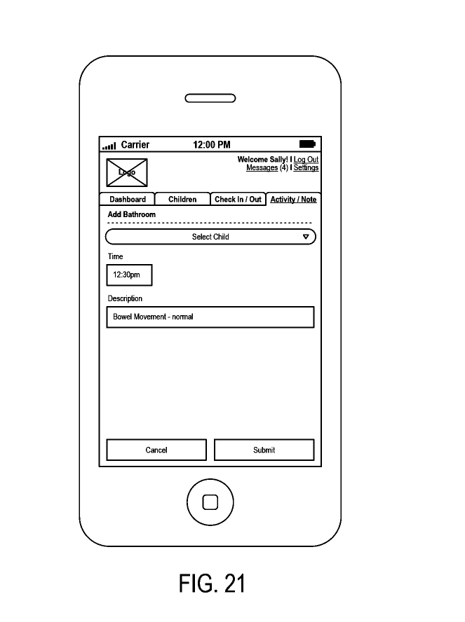

FIG. 21 shows an exemplary activity entry. In this example, a bathroom is added, where one or more children are selected, the time is entered either automatically or manually, bathroom activities are entered, etc. Additional items may be added, if necessary.

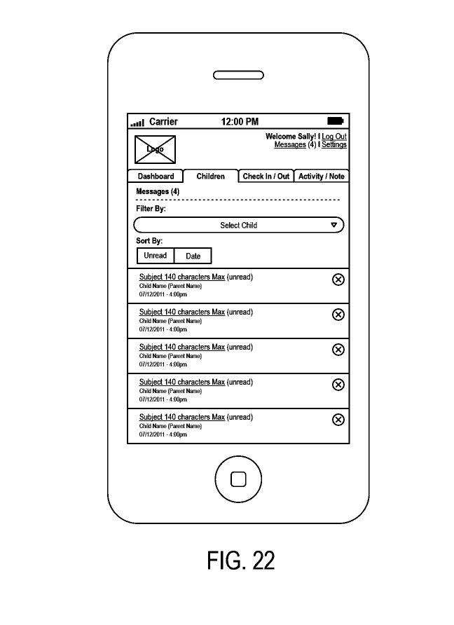

FIG. 22 shows a message system. Filters may be applied, such as by date/time, recipient, sender, subject matter, child, etc.

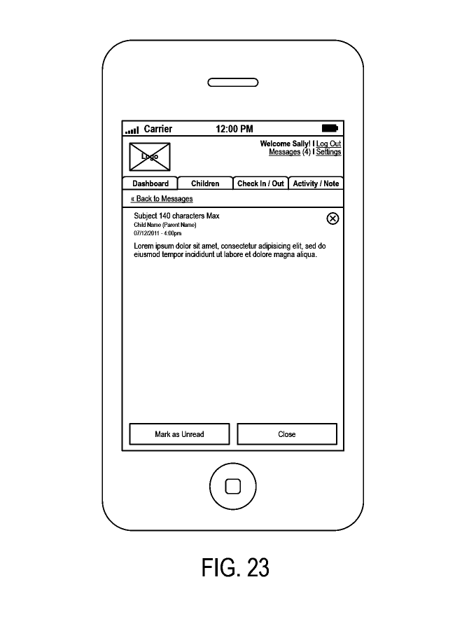

FIG. 23 shows a message reading system. Messages may be read, marked, deleted, archived, sorted, etc. as in typical email or text message systems. A user may reply, reply all, forward, etc. a particular message.

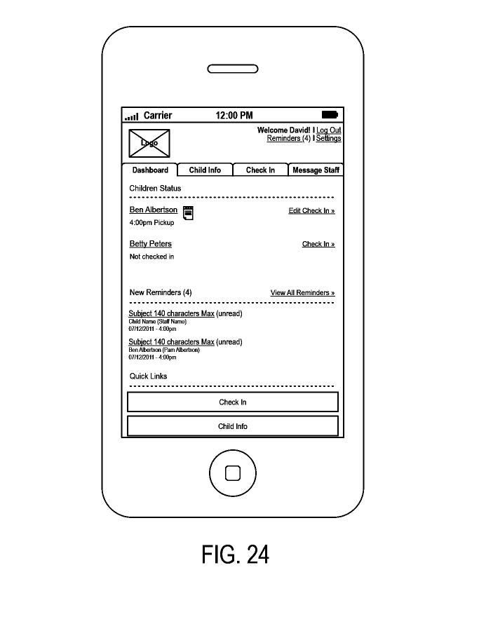

FIGS. 24-42 show exemplary screenshots of various parent facing activities via the systems and methods of the present invention.

FIG. 24 shows a dashboard with all children whose information is available to a parent. Data may include the child's status, such as name, checked in/checked out status, reminders, messages, etc. The user may select a child's name to receive additional information. Entry devices for check in and check out may be provided to change the status of a particular child.

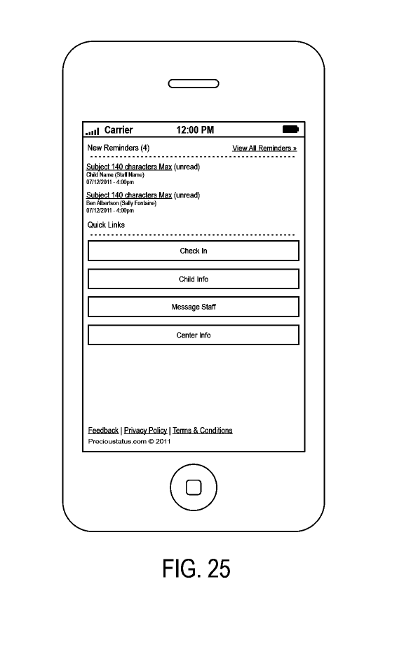

FIG. 25 shows a selection page. The user may view messages, and/or select from various actions, such as check in, check out, message staff/facility, facility information, etc.

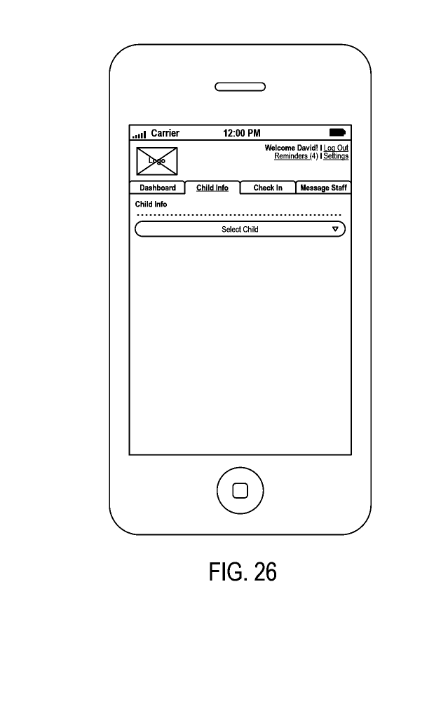

FIG. 26 shows a child selection page. The user may select one or more children from a list, drop-down menu, etc.

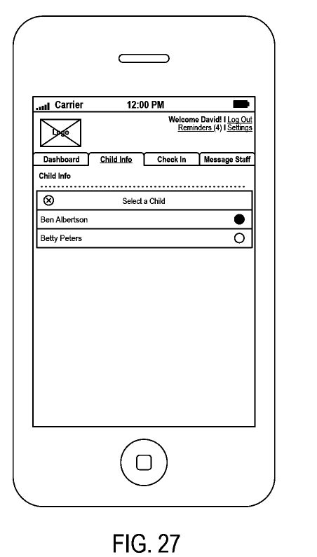

FIG. 27 shows a child selection system. The system may include one or more indicators of child status.

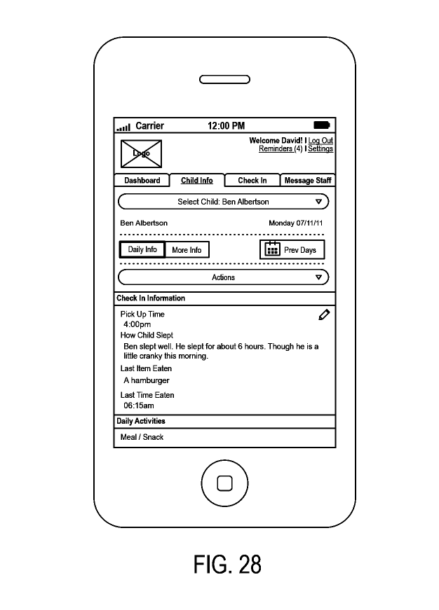

FIG. 28 shows a child overview system. The selected child may be indicated, along with daily information, more information, previous day information, activity stream, notes, messages, reminders, etc.

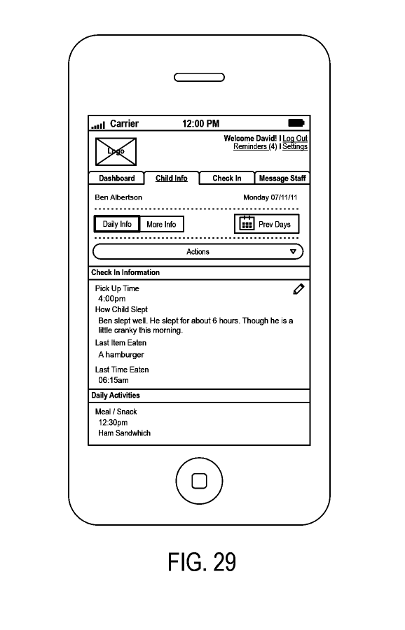

FIG. 29 shows a system with additional information, such as details regarding particular activities for a selected child.

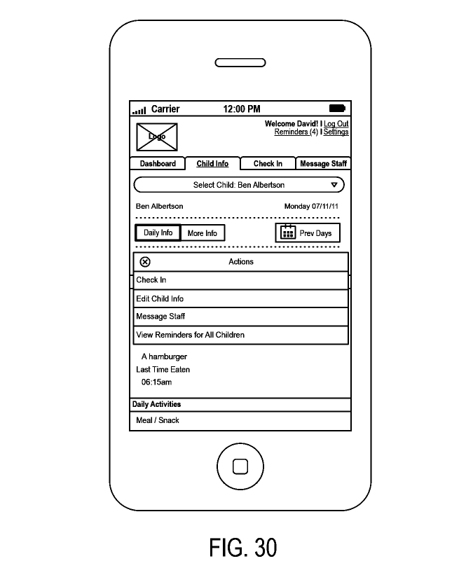

FIG. 30 shows potential actions for a user. Exemplary actions may include check in, edit child information, message staff, view reminders, view messages, etc.

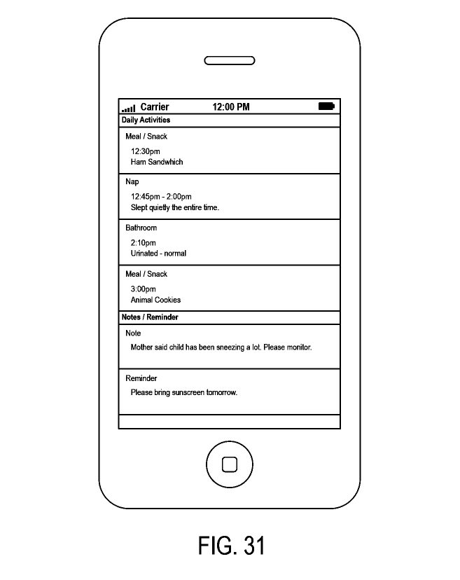

FIG. 31 shows an activity stream for a selected child. The activity stream may include meals/snacks, naps, bathroom activities, notes, reminders, etc. Various levels of detail may be provided.

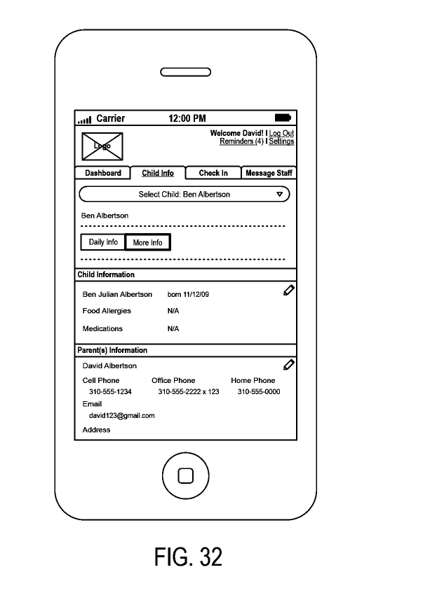

FIG. 32 shows child information.

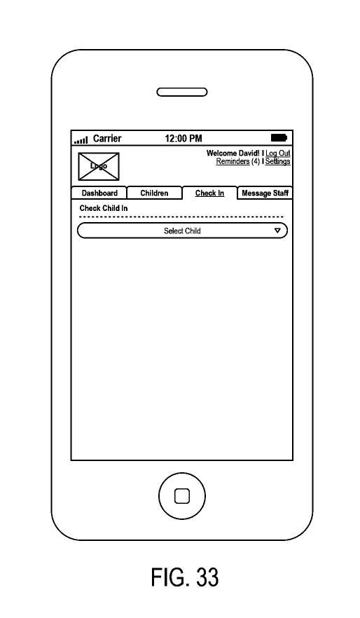

FIG. 33 shows child check in where the user may select a child for check in.

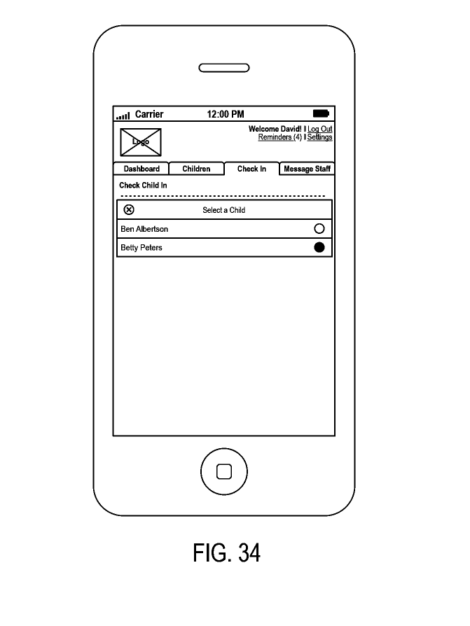

FIG. 34 shows potential selections for children and check in status.

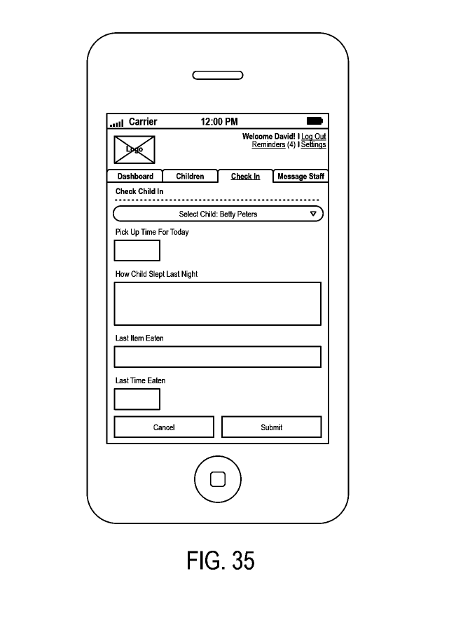

FIG. 35 shows a data entry system for check in. The user may enter time for pick up, sleep information, food information, etc.

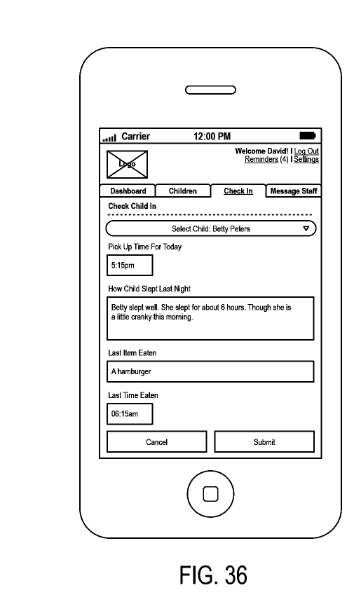

FIG. 36 shows the form of FIG. 35 completed.

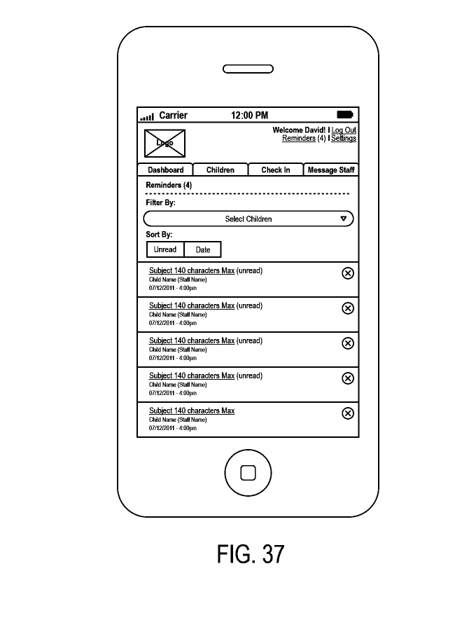

FIG. 37 shows a message receiving system.

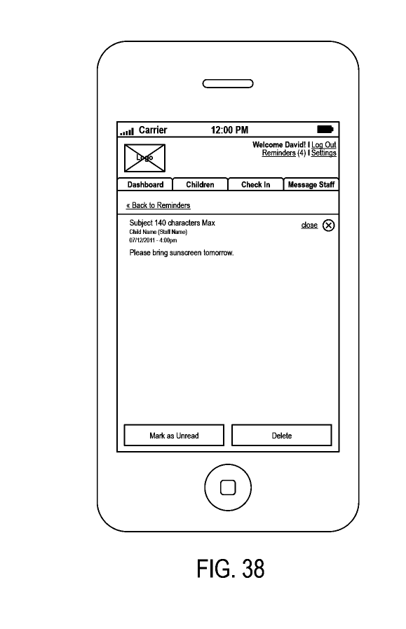

FIG. 38 shows a reminder system.

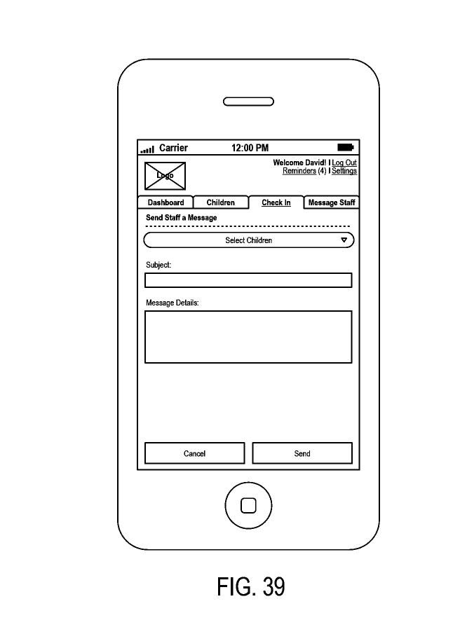

FIG. 39 shows a message system for allowing a parent to message a staff member and/or the facility.

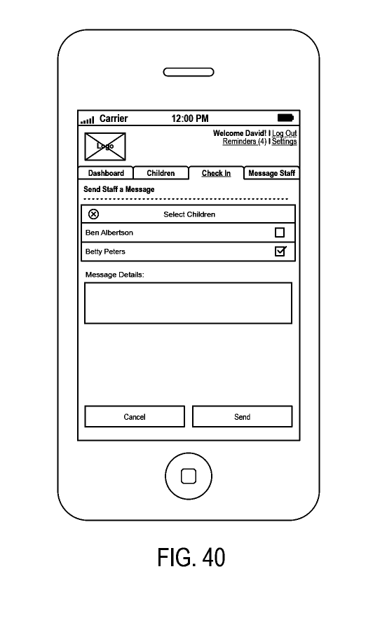

FIG. 40 shows a selection system for linking messages to one or more children.

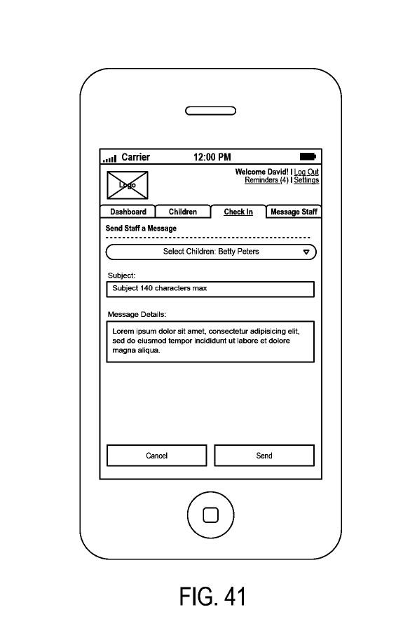

FIG. 41 shows an email message system.

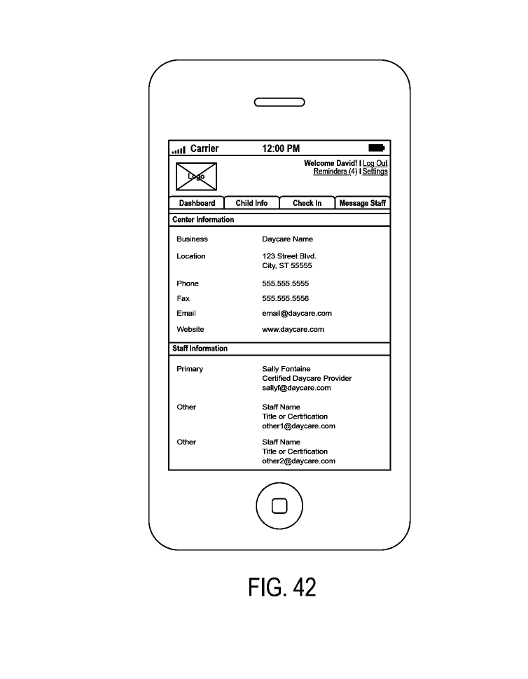

FIG. 42 shows a center information system. The center information may include name, address, phone number, fax number, email, website, staff information, etc.

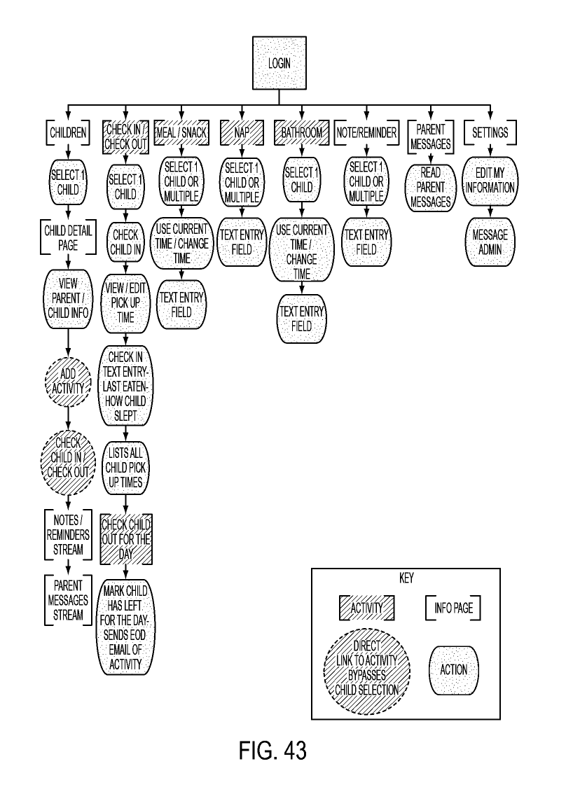

FIG. 43 shows a system for daycare user actions. A user may login to the system. For children being cared for, the user may select one or more children, view a child detail page, view parent/child information, add activity, check children in and/or out, view notes/reminders stream, view parent message stream, etc. For check in/check out, the user may select one or more children, check children in, view/edit pick up times, enter text at check in, list all child pick up times, check children out, mark that children have left for the day, send email of activities/daily report, etc. For meal/snack, the user may select one or more children, use current time or change time, enter text, etc. For bathroom, the user may select one or more children, use current time or change time, enter text, etc. For notes/reminders, the user may select one or more children, enter text, etc. For parent messaging, the user may read parent messages. For settings, the user may edit personal information, adjust message administration settings, etc.

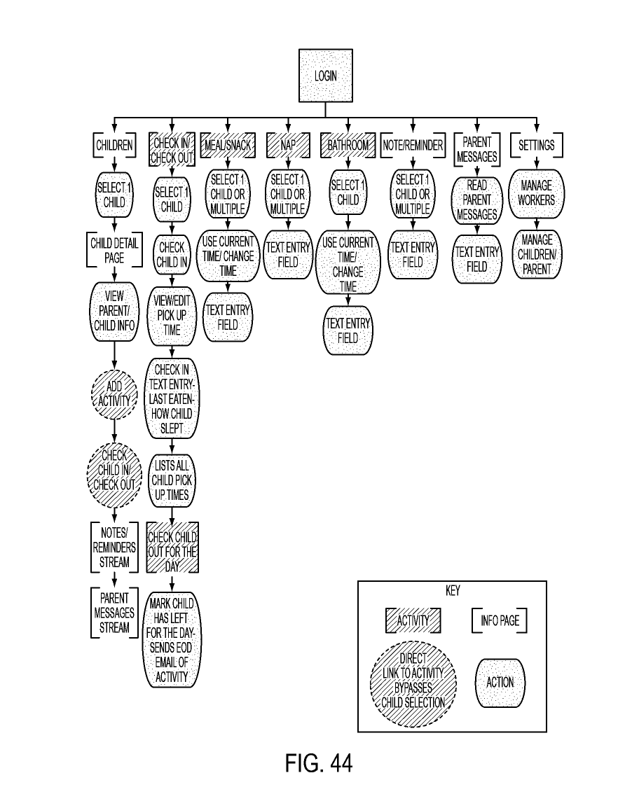

FIG. 44 shows a system for daycare administrator user actions. A user may login to the system. For children being cared for, the user may select one or more children, view a child detail page, view parent/child information, add activity, check children in and/or out, view notes/reminders stream, view parent message stream, etc. For check in/check out, the user may select one or more children, check children in, view/edit pick up times, enter text at check in, list all child pick up times, check children out, mark that children have left for the day, send email of activities/daily report, etc. For meal/snack, the user may select one or more children, use current time or change time, enter text, etc. For bathroom, the user may select one or more children, use current time or change time, enter text, etc. For notes/reminders, the user may select one or more children, enter text, etc. For parent messaging, the user may read parent messages, enter text, etc. For settings, the user may manage workers, manage children/parents, etc.

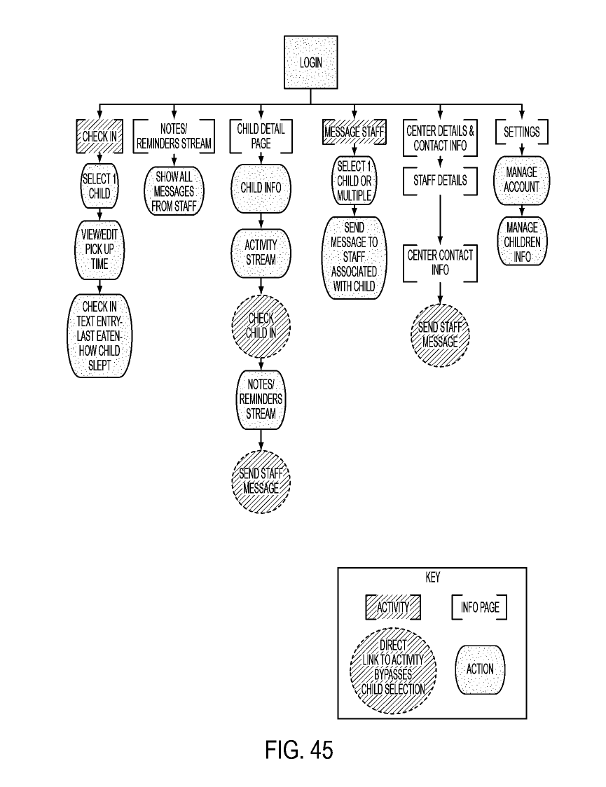

FIG. 45 shows parent user actions. A user may login to the system. For check in, the user may select one or more children, view/edit pick up time, provide check in text entry, etc. For notes/reminders, the user may show one or more messages from the staff/facility. For child detail, the user may view child info, activity stream, child check in, notes/reminders, send messages, etc. For message staff, the user may select one or more children, send messages to staff associated with one or more children, etc. For facility details and contact information, the user may view staff details, facility contact information, send messages, etc. For settings, the user may manage a personal account, manage child information, etc.

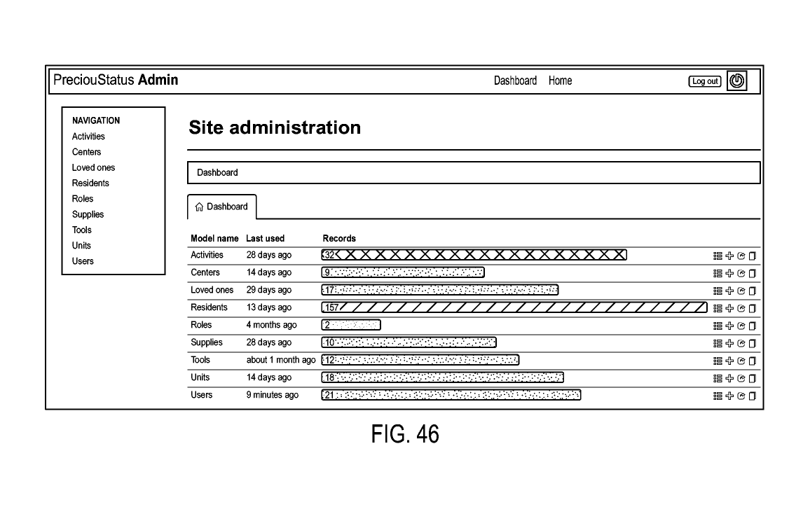

FIG. 46 shows an interface for site administration. A navigation panel is provided on the left. The navigation panel lists different options to view. Options may include, for example, Activities, Centers, Loved ones, Residents, Roles, Supplies, Tools, Units, Users. Activities may include activities that care receivers may engage in. Centers may include the facilities that the site provides administration for. Loved ones may include the individuals monitoring status updates for the care receivers. Residents may include the care receivers. Roles may include the individuals providing care to the care receivers. Supplies may include supplies needed for activities. Users may include accounts for those accessing the site.

The interface for site administration may also include a dashboard showing the number of records in each of the options in the navigation, and the last time the option was used.

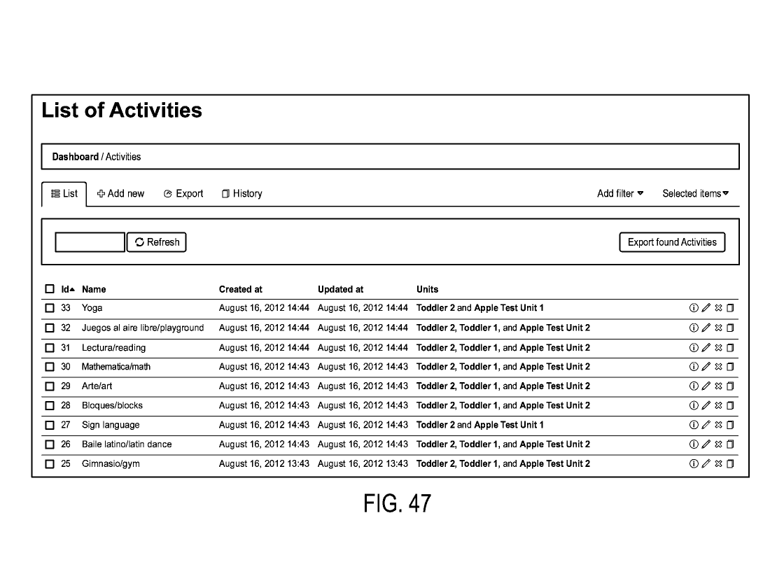

FIG. 47 shows an interface for listing activities. Activities may include, for example, Yoga, reading, math, art, blocks, Sign language, latin dance, gym, etc. Each activity may be associated with an Id, a name, a creation date/time, an update date/time, and one or more units. The Id may be a number unique to the activity. The associate one or more units may designate which units may have care receivers associated with the unit associate with the activity.

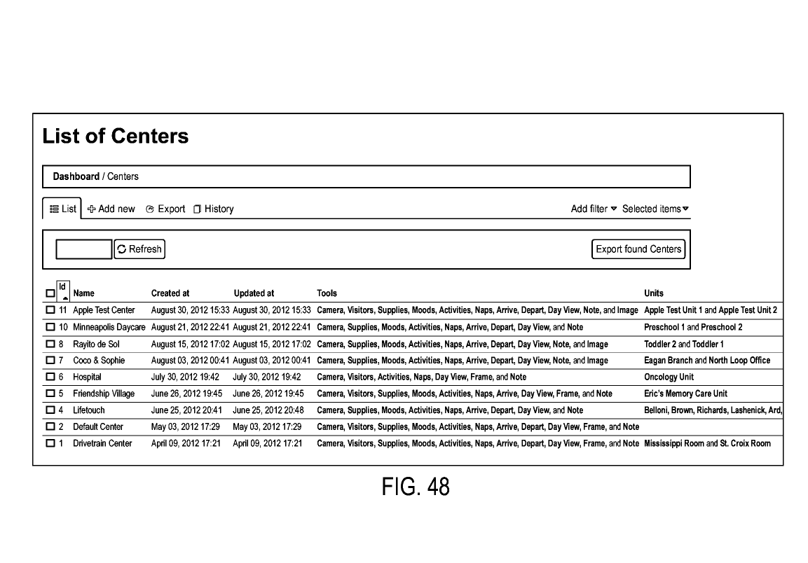

FIG. 48 shows an interface for listing facilities. The facilities may be associated with an Id, a name, a creation date/time, an update date/time, tools, and units. The tools and units may identify which tools and units are used for the facility.

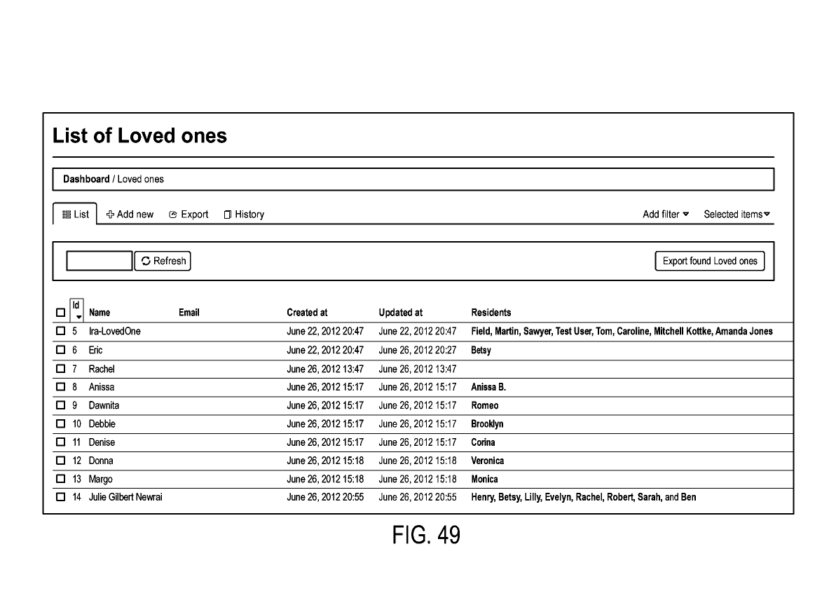

FIG. 49 shows an interface for listing monitoring individuals. The monitoring individuals may be associated with an Id, a name, an email address, a creation date/time, an update date/time, and one or more residents. The system may determine who to send the status updates to based on the associated residents.

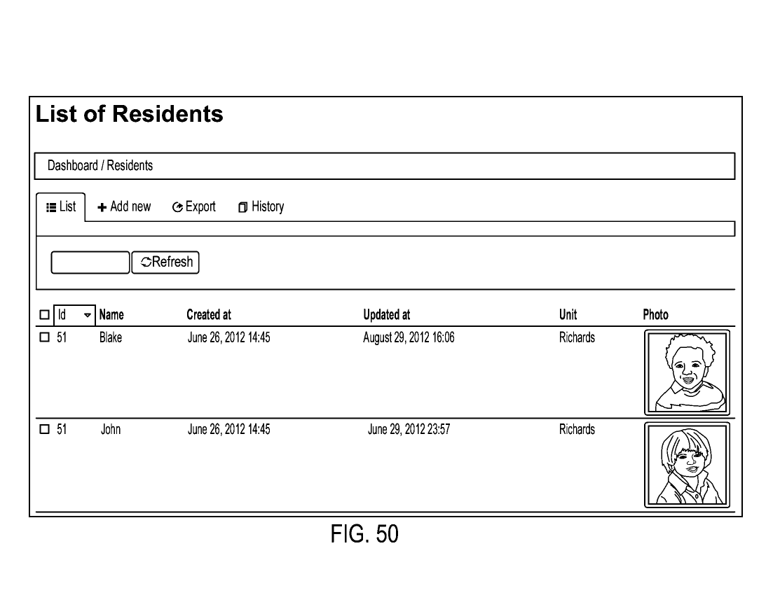

FIG. 50 shows an interface for listing care receivers. The care receivers are associated with an Id, a name, a creation date/time, an update date/time, a unit, and a photo.

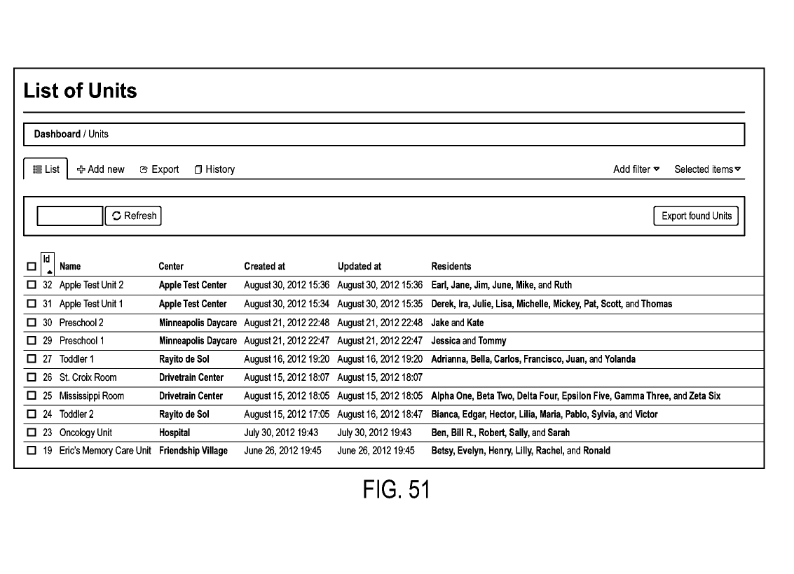

FIG. 51 shows an interface for listing units. The units are associated with an Id, a name, a facility, a creation date/time, an update date/time, and one or more residents.

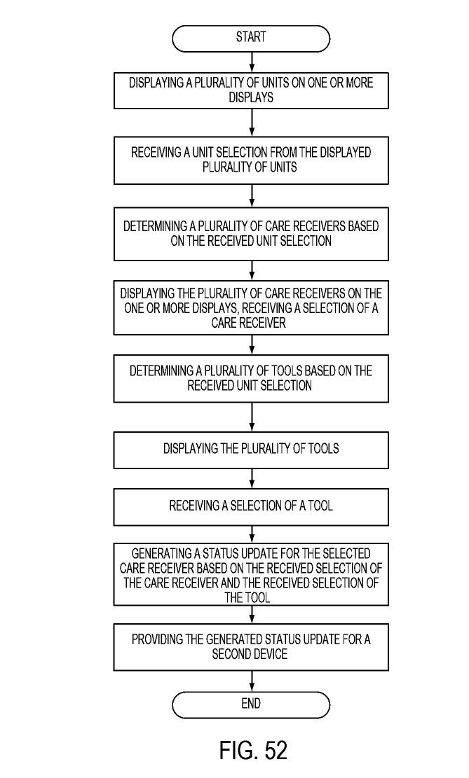

FIG. 52 shows an exemplary process for providing status updates. The process may include displaying a plurality of units on one or more displays, receiving a unit selection from the displayed plurality of units, determining a plurality of care receivers based on the received unit option, displaying the plurality of care receivers on the one or more displays, receiving a selection of a care receiver, determining a plurality of tools based on the received unit selection, the tools of the plurality of tools corresponding to interfaces for providing status updates for care receivers, displaying the plurality of tools, receiving a selection of a tool, generating a status update for the selected care receiver based on the received selection of the care receiver and the received selection of the tool, and providing the generated status update for a second device.

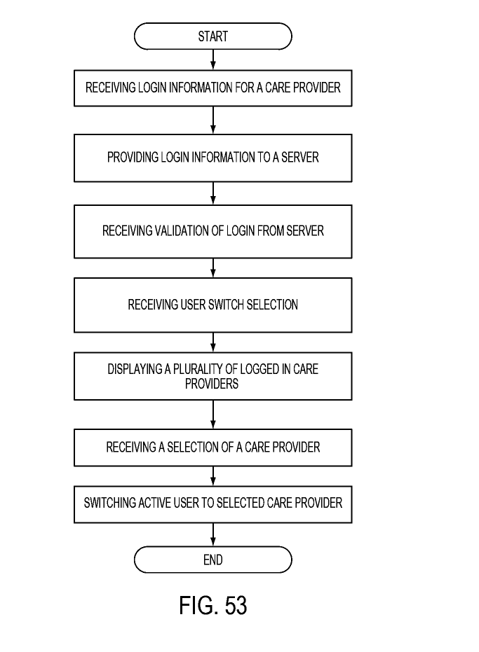

FIG. 53 shows an exemplary process for switching users. Client computing devices 106 may be shared by a plurality of care providers. When a care provider initially accesses a client computing device 106, the care provider may first enter into log-in information for the care provider to access an account associated with the care provider. Log-in information may include a user name and password. Once a care provider logs in the care provider may be the active user of the client computing device 106. The active user may be associated with all updates generated using the client computing device 106 and may determine the information displayed on the client computing device 106.

If sharing a client computing device 106 with multiple care providers, it may be inefficient to require care providers to log out and log back into a client computing device 106. Accordingly, client computing devices 106 may enable care providers to switch between logged in care providers, which may also be referred to as users.

The client computing devices 106 may receive login information for a care provider. The login information may be a user name and password. The client computing device 106 may provide the information to a server 102. The server 102 may authenticate the login information to determine the information does correctly correspond to a registered care provider. The server 102 may provide a validation and the client computing device 106 may receive validation of login from the server 102.

When a plurality of care providers are logged into a client computing device 106, the client computing device 106 may receive a user switch selection. For example, the client computing device 106 may display a toggle which a care provider may select to indicate that the user of the client computing device 106 should be switched to another logged in care provider. Upon receiving a user switch selection, client computing device 106 may display a plurality of logged in care providers. Logged in care providers may be displayed by a drop down list, a grid view, radio buttons, etc.

Client computing device 106 may receive a selection of a care provider from the displayed plurality of care providers. Client computing device 106 may switch the active user of the client computing device 106 to the care provider.

The duration a care provider is logged in may be determined by the care provider or may be determined by the system. For example, care providers may never be automatically logged out of a client computing device 106 and may need to manually select to log out, or care providers may be logged out after the care providers is not made the active user within a predetermined amount of time identified by the care provider or system, for example, one hour.

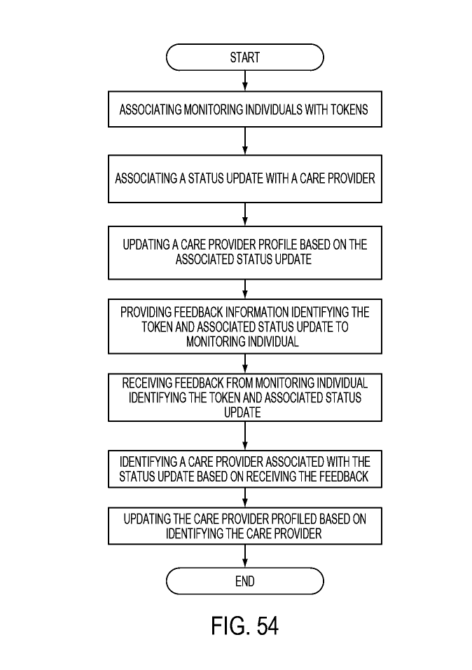

FIG. 54 shows an exemplary process for associating updates with care providers. Care providers may be rewarded for providing status updates and may further be rewarded for receiving positive feedback from monitoring individuals in response to the status updates. Accordingly, care providers may be incentivized to provide status updates which monitoring individuals will appreciate.

Server 102 may associate monitoring individuals with tokens. Tokens may be unique identifiers for monitoring individuals. The server 102 may associate status updates with a care provider. For example, server 102 may associate a status update generated using client computing device 106 with the care provider that was the active user of the client computing device 106 at the time the status update was generated.

Server 102 may update a care provider profile based on the associated status. Each care provider may be associated with a care provider profile that tracks a number of points that the care provider has received. For example, the care provider may be provided points based on generating status updates which are associated with the care provider. The care provider's profile may be updated to reflect the provided points. The amount of points provided for status updates may be constant for all status updates or may be variable based on the type of status update. The amount of points provided to the care provider may expire after a certain period of time, e.g., a day, month, year, or any other period of time. The amount of points may vary based on the type or number of status updates generated.

Monitoring individuals may also provide positive feedback in response to status updates. Server 102 may provide feedback information identifying monitoring individual's tokens and an associated status update to a monitoring individual. The monitoring individual may provide positive feedback to the status update and the server 102 may receive the feedback from monitoring individual. The feedback received may identify the token and associated status update receiving the positive feedback. The server 102 may identify a care provider associated with the status update identified in the feedback. The server 102 may then update the care provider's profile to add points based on receiving the positive feedback from the monitoring individual. The amount of points provided to the care provider may expire after a certain period of time, e.g., a day, month, year, or any other period of time. The amount of points may vary based on the type of status update to which the feedback pertains, the number of feedback responses provided for the status update, or any combination thereof.

The feedback information provided to the monitoring individual may include a button at the bottom of an e-mail, a link in a SMS text message, etc. The feedback information may allow a monitoring individual to follow a Uniform Resource Locator (URL) which identifies the update to receive the positive feedback. The server 102 may further track the number of positive feedbacks received by care providers or received for a status update. The server 102 may increase the number of points provided to the care provider based on the number of positive feedbacks received by the care provider or received for a status update.

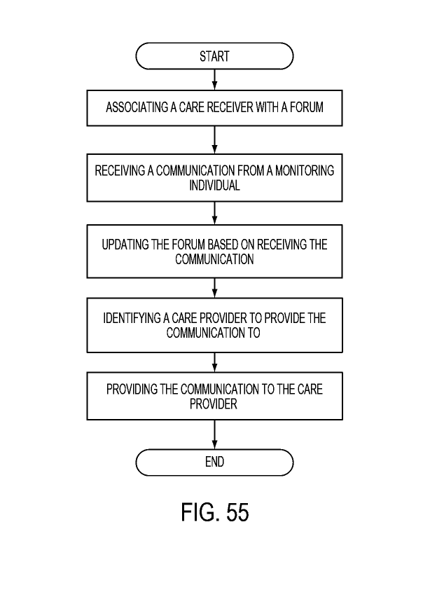

FIG. 55 shows an exemplary process for communicating between monitoring individuals and care providers. Server 102 may associate a care receiver with a forum. A forum may be an environment where communications may be left. The forum may be restricted to access by only monitoring individuals associated with the care receiver and care providers associated with the care receiver. Each monitoring individual may have a token associated with the monitoring individual so communications may be associated with specific monitoring individuals. Communications may be left by monitoring individuals for care providers. For example, communications may include a message “Remember to wish my dad happy birthday!”

Server 102 may receive a communication from a monitoring individual for a forum of a care receiver. Server 102 may update the forum associated with the care receiver. Server 102 may identify a care provider to provide the communication to. For example, server may display an icon indicating that the care receiver has an associated communication. The icon may be displayed next to the care receiver's portrait. Once a care provider selects to view the communication, the server may identify the care provider as the care provider to provide the communication to and provide the communication to the care provider.

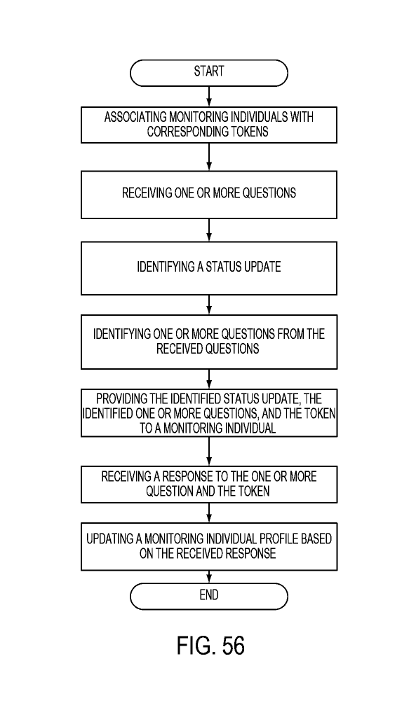

FIG. 56 shows an exemplary process for providing questions to monitoring individuals. Server 102 may associated monitoring individuals with corresponding tokens. Server 102 may receive one or more questions. The one or more questions may be part of a survey regarding care provided. Server 102 may identify a status update to be sent to a monitoring individual and identify one or more questions from the received questions to provide to the monitoring individual along with the status update. For example, server 102 may determine which questions have not been provided to the monitoring individual based on a profile associated with the monitoring individual.

Server 102 may provide the identified status update, the identified one or more questions, and the token to the monitoring individual. The monitoring individual may provide a response to the question along with the token. Server 102 may receive the response to the question and the token. Server 102 may identify the monitoring individual's profile using the received token and update the monitoring individual's profile based on the received response.

Although the foregoing description is directed to the preferred embodiments of the invention, it is noted that other variations and modifications will be apparent to those skilled in the art, and may be made departing from the spirit or scope of the invention. Moreover, features described in connection with one embodiment of the invention may be used in conjunction with other embodiments, even if not explicitly stated above. The present invention may be embodied in other specific forms without departing from its spirit or essential characteristics. The described embodiments are to be considered in all respects only as illustrative and not restrictive.

1. A method for providing status updates using a device, the device comprising one or more processors, one or more displays, and one or more input interfaces, the method comprising:
displaying a plurality of units on the one or more displays, the units corresponding to locations within a facility;
receiving, using the one or more input interfaces, a unit selection from the displayed plurality of units;
determining, using the one or more processors, a plurality of care receivers based on the received unit selection;
displaying the plurality of care receivers on the one or more displays;
receiving, using the one or more input interfaces, a selection of a care receiver;
determining, using the one or more processors, a plurality of tools based on the received unit selection, the tools of the plurality of tools corresponding to interfaces for providing status updates for care receivers;
displaying the plurality of tools on the one or more displays;
receiving, using the one or more input interfaces, a selection of a tool;
generating, using the one or more processors, a status update for the selected care receiver based on the received selection of the care receiver and the received selection of the tool; and
providing, using the one or more processors, the generated status update for a second device.

2. The method of claim 1, wherein determining the plurality of care receivers comprises:
identifying a unit associated with the received unit selection;
identifying associations of the identified unit with care receivers; and
identifying care receivers associated with the identified unit based on the identified associations.

3. The method of claim 1, wherein determining the plurality of tools comprises:
identifying a unit associated with the received unit selection;
identifying associations of the identified unit with tools; and
identifying tools associated with the identified unit based on the identified associations.

4. The method of claim 1, wherein determining the plurality of tools comprises:
determining the plurality of tools based on the received selection of the care receiver.

5. The method of claim 1, wherein the provided generated status update is provided to a server for the server to provide to the second device.

6. The method of claim 1, wherein the status update comprises information identifying the received selection of the care receiver and an activity associated with the received selection of the tool.

7. The method of claim 1, wherein the facility comprises at least one of: a daycare, a school, a learning center, a rehabilitation center, a hospital, an eldercare center, an assisted healthcare home, or a pet daycare.

8. At least one non-transitory tangible computer-readable medium holding instructions, which, when executed by at least one computing device, cause the at least one computing device to provide a status update, the instructions comprising:
one or more instructions for displaying a plurality of units, the units corresponding to locations within a facility;
one or more instructions for receiving a unit selection from the displayed plurality of units;
one or more instructions for determining a plurality of care receivers based on the received unit selection;
one or more instructions for displaying the plurality of care receivers;
one or more instructions for receiving a selection of a care receiver;
one or more instructions for determining a plurality of tools based on the received unit selection, the tools of the plurality of tools corresponding to interfaces for providing status updates for care receivers;
one or more instructions for displaying the plurality of tools;
one or more instructions for receiving a selection of a tool;
one or more instructions for generating a status update for the selected care receiver based on the received selection of the care receiver and the received selection of the tool; and
one or more instructions for providing the generated status update for a second device.

9. The medium of claim 8, wherein the one or more instructions for determining the plurality of care receivers comprises:
one or more instructions for identifying a unit associated with the received unit selection;
one or more instructions for identifying associations of the identified unit with care receivers; and
one or more instructions for identifying care receivers associated with the identified unit based on the identified associations.

10. The medium of claim 8, wherein the one or more instructions for determining the plurality of tools comprises:
one or more instructions for identifying a unit associated with the received unit selection;
one or more instructions for identifying associations of the identified unit with tools; and
one or more instructions for identifying tools associated with the identified unit based on the identified associations.

11. The medium of claim 8, wherein the one or more instructions for determining the plurality of tools comprises:
one or more instructions for determining the plurality of tools based on the received selection of the care receiver.

12. The medium of claim 8, wherein the provided generated status update is provided to a server for the server to provide to the second device.

13. The medium of claim 8, wherein the status update comprises information identifying the received selection of the care receiver and an activity associated with the received selection of the tool.

14. The medium of claim 8, wherein the facility comprises at least one of: a daycare, a school, a learning center, a rehabilitation center, a hospital, an eldercare center, an assisted healthcare home, or a pet daycare.

15. The medium of claim 8, further comprising one or more instructions for:
receiving login information for a care provider;
receiving a user switch selection;
displaying a plurality of logged in care providers;
receiving a selection of a care provider; and
switching an active user to the selected care provider;

16. A system to provide status updates, the system comprising:
one or more tangible non-transitory media storing program data; and
one or more processors coupled to the one or more tangible non-transitory media, the processor configured to:
define a plurality of units corresponding to locations within a facility;
define a plurality of care receivers associated with the plurality of units;
define a plurality of tools associated with the plurality of units;
provide the plurality of units, plurality of care receivers, and plurality of tools to a client computing device;
receive a status update from the client computing device;
update the program data based on the received status update; and
provide the status update to a second client computing device.

17. The system of claim 16, wherein locations within the facility comprises individual rooms associated with corresponding types of care receivers within the facility.

18. The system of claim 16, wherein the program data comprises data regarding the facility, care receivers, and tools.

19. The system of claim 16, wherein provide the status update comprises sending a message to the second client computing device, the message comprising information identifying a care receiver of the plurality of care receivers and identifying an activity associated with a tool of the plurality of tools.

20. The system of claim 16, the processor further configured to:
associate monitoring individuals with tokens;
associate a status update with a care provider; and
update a care provider profile based on the associated status update.

21. The system of claim 16, the processor further configured to:
associate a care receiver with a forum;
receive a communication from a monitoring individual;
update the forum based on receiving the communication;
identifying a care provider to provide the communication to; and
providing the communication to the care provider.

22. The system of claim 16, the processor further configured to:
associate the monitoring individuals with corresponding tokens;
identify a status update;
identify one or more questions;
provide the identified status update, identified one or more questions, and the token to a monitoring individual;
receiving a response to the one or more questions and the token; and
updating a monitoring individual profile based on the received response and token.

23. The system of claim 16, wherein the care receiver is at least one of an infant, a toddler, a pre-school student, a student, a resident, a pet, a person, and an animal.

24. The system of claim 16, wherein at least one of the units may correspond to a room in or a portion of at least one of a daycare, a hospital, a school, a learning center, a rehabilitation center, an eldercare facility, a home, an assisted healthcare facility, a pet residence, a doggy daycare, a kennel, and a veterinary hospital.
